(19) United States
(12) Patent Application Publication
(10) Pub. No.: US 2013/0105013 A1
(43) Pub. Date: May 2, 2013

(54) Septic field filter and bacterial unit

(71) Applicant: Kenneth Burrows, Wellington (CA)

(72) Inventor: Kenneth Burrows, Wellington (CA)

(21) Appl. No.: 13/317,837

(22) Filed: Oct. 31, 2011

(51) Int. Cl. F15D 1/00

(52) U.S. Cl. 137/597

(57) ABSTRACT

An even-flow tee arrangement for use with a septic system consists of a tee connector having top and bottom section cemented together. The bottom section includes a splitter plate extending from the tee-shaped exit end to two pairs of directional vanes proximate the entrance end of the tee connector.

### BACKGROUND OF THE INVENTION

Septic systems of the type connecting a septic holding tank and a distribution field often employ a filter arrangement between the holding tank and the leaching field to prevent solids from clogging septic tank. One such filter is a WW Residential Effluent Filter distributed by Zoeller Pump Co, Louisville Md.

The filters include access thereto to replace the filters over extended periods of use.

The filters, per se, are unable to completely prevent fats, greases, and other solids from that can clog the septic field over such periods of extended use thereof.

Accordingly, one purpose of the instant invention is to provide an arrangement whereby bacterial and aerobic function is associated with the septic filter to ingest the fats, greases, and other contaminants that would otherwise coat the sand and gravel within the septic field.

### SUMMARY OF THE INVENTION

A septic field filter and bacterial unit container in the form of vertical T-shaped configuration is connected between the septic tank and the septic field.

A removable filter is arranged within the container, intermittent the input and output connectors for filtering the effluents from the septic tank and a large bacterial tablet is arranged beneath the filter for providing bacterial function to the filtered effluents prior to contact with the septic field. A perforated cover arranged on the top of the container superjacent the filter and the tablet to allow intake air to contact and oxidize the effluents.

### BRIEF DESCRIPTION OF THE DRAWINGS

FIG. 1 is a front view of septic field filter and bacterial unit container arrangement according to the invention; and

FIG. 2 is a top perspective view of the septic field filter and bacterial unit container of FIG. 1 including the filter and bacterial unit therein.

### DESCRIPTION OF THE PREFERRED EMBODIMENT

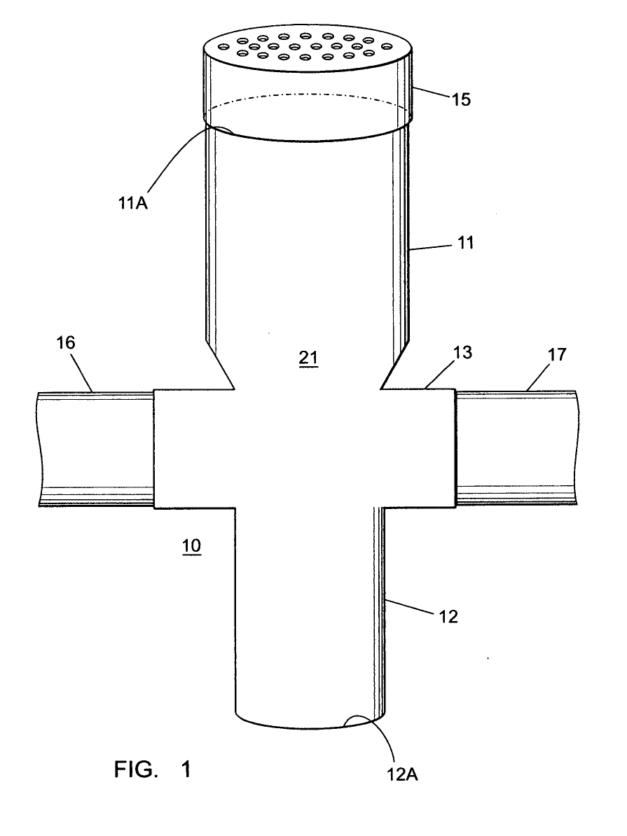

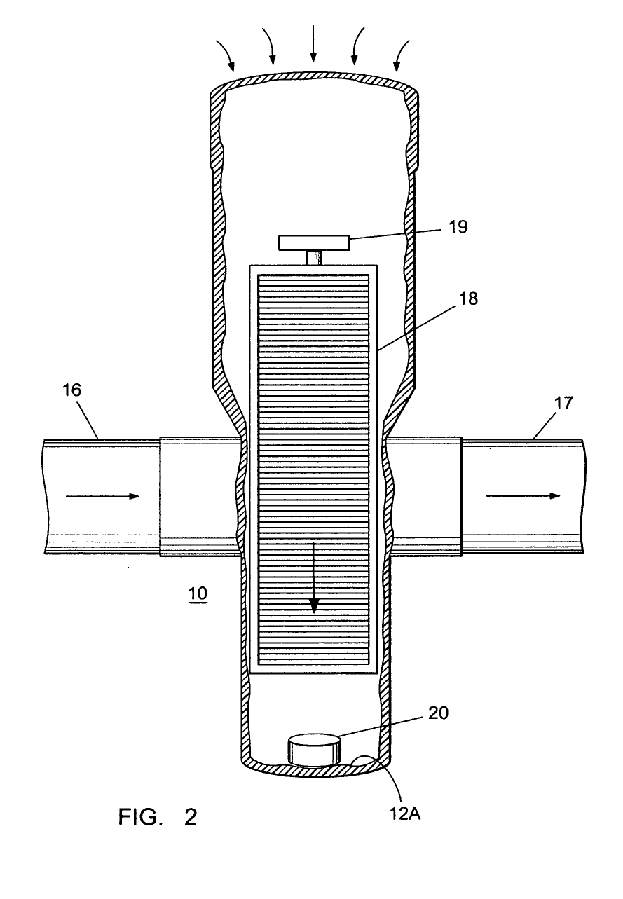

The even-flow septic tee 10 shown in FIGS. 1 and 2 consists of a top plate 11 and bottom plate 12 made of pvc (polyvinyl chloride) plastic material defining a tee-shaped outlet 13 at one end and a circular inlet opening 14 at the opposite end thereof. A level line 21 is formed on the top of the tee-shaped outlet 13 to assist in aligning the even- flow septic tee 10 with respect to the parallel plane 18, during installation.

The elongated even-flow septic tee 10 defines a linear section 19 roughly twice the length of the tee-shaped outlet 13 when the top and bottom plates 11, 12 are cemented together, as indicated at 20. The tee-shaped outlet 13 includes opposite side openings 15, 16 for fluid transfer out from the even-flow septic tee 10 in the manner to be described below in greater detail. Each of the openings 14-16 has enlarged collars 14A-16A for attachment with inlet and outlet piping as described in the aforementioned U.S. Pat. No. 6,012,871.

In accordance with the teachings of the invention, the even- flow septic tee 10 is shown in FIG. 2 prior to attaching the top plate 11 and bottom plate 12 wherein a splitter plate 22 is shown integrally-formed within the bottom 12A of the bottom plate 12 intermediate the opposite side openings 15, 16 and extending along the bottom plate 12 proximate the inlet opening 14 shown in FIG. 1. A pair of right flow directional vanes 23 is formed on the bottom 12A to the right of the end of the splitter plate 22 and a pair of left flow directional vanes 24 is formed on the bottom 12A to the left of the end of the splitter plate intermediate the end of the splitter plate and the inlet opening 14.

The operation of the even-flow septic tee 10 is best understood by now referring to the even-flow septic tee 10 shown in FIG. 3 wherein the even- flow septic tee 10 is shown with the top plate 11 of FIG. 1 removed to depict the bottom plate 12 with fluid 25 transferring from into the inlet opening 14 and out of the opposite side openings 15, 16, as indicated by arrows 26-28 accordingly. The function of the right flow directional vanes 23 and left flow directional vanes 24 is to direct the flow of fluid 25 toward the middle of the splitter plate 22, which, in turn, divides the fluid flow equally outwards toward opposite side openings 15, 16, even when the level line 21 on the top of the tee-shaped outlet 13 in FIG. 1 is out of alignment with respect to the parallel plane 18,which often occurs in septic systems, due to a variety of reasons.

An elongated even-flow septic tee for connection between a holding tank and a distribution field in septic systems has herein been described. The even-flow septic tee includes means therein for compensating fluid flow distribution between the connecting distribution lines when the even-flow septic tee becomes displaced from the horizontal position of installation.

What is claimed is:

1. A connector between a septic tank and distribution field comprising:
an elongated tee having an inlet for connection with a septic tank, and a pair of outlets for connecting with a distribution field; and
means for providing fluid transfer thru said pair of outlets when said pair of outlets is off-set with a plane parallel with said distribution field.

2. The connector of claim 1 wherein said elongated tee includes a splitter plate arranged between said inlet and said outlets therein for dividing said fluid transfer between said pair of outlets.

3. The connector of claim 2 further including a first pair of deflecting vanes on one side of said splitter plate for directing said fluid flow to said one side of said splitter plate.

4. The connector of claim 3 including a second pair of deflecting vanes on another side of said splitter plate for directing said fluid flow to said other side of said splitter plate.

5. The connector of claim 4 wherein said first and second pair of deflecting vanes are proximate said inlet.

6. The connector of claim 1 wherein said elongated tee comprises plastic.

7. The connector of claim 1 wherein said elongated tee comprises a top plate and a bottom plate said top plate being cemented to said bottom plate.

8. The connector of claim 1 wherein said elongated tee defines a first length extending between said inlet and said outlets.

9. The connector of claim 8 wherein said elongated tee defines a second length extending between said pair of outlets.

10. The connector of claim 9 wherein said linear section is longer than said second section.
